(19) United States
(12) Patent Application Publication
(10) Pub. No.: US 2019/0040514 A1
(43) Pub. Date: Feb. 7, 2019

(54) SYNERGY FOR IMPROVED THERMAL SPRAY ADHESION

(71) Applicant: GM GLOBAL TECHNOLOGY OPERATIONS LLC, Detroit, MI (US)

(72) Inventors: Su Jung Han, West Bloomfield, MI (US); Martin S. Kramer, Clarkston, MI (US); Peng Lu, Troy, MI (US); Zhe Li, Rochester, MI (US); Yucong Wang, West Bloomfield, MI (US)

(21) Appl. No.: 15/668,027

(22) Filed: Aug. 3, 2017

(51) Int. Cl. C23C 4/02; C23C 4/12; C23C 4/06; F02F 1/00

(52) U.S. Cl. CPC C23C 4/02; C23C 4/12; F02F 2200/00; F02F 1/004; C23C 4/06

(57) ABSTRACT

A method of coating an inner surface of an engine cylinder bore includes cleaning the surface to remove carbon, resulting in the surface having a maximum of 30 atomic percent carbon, texturing the surface to achieve a developed interfacial area ratio of at least 100%, and heating the surface to between 100-200 degrees Celsius. A thermal spray coating is then adhered to the surface. In some cases, a force of 25+ Newtons scratched across the thermal spray coating is required to remove the thermal spray coating from the surface. Maximum adhesion strength is achieved when the coating is applied to: 1) a heated surface that has 2) an Sdr of at least 100% and 3) a maximum of 20 atomic percent of carbon on the surface. When these three criteria are all present, adhesion strength can be 50 Newtons or more with evidence of metallurgical diffusion/bonding at the interface.

### FIELD

The present disclosure relates to improving the adhesion of thermal spray coatings to substrates.

### INTRODUCTION

Thermal spraying is a coating process which applies material heated and typically melted by combustion or an electrical plasma or arc to a substrate. The process is capable of rapidly applying a relatively thick coating over a large area relative to other coating processes such as electroplating, sputtering, and physical and vapor deposition.

The ruggedness and durability of the thermal spray coating would seem to be almost exclusively a feature of the material of the coating and to a lesser extent the quality of application. However, it has been determined that, in fact, typically the most significant factor affecting the ruggedness and durability of a thermal spray coating is the strength of the bond between the thermal spray coating and the substrate. A poor bond may allow the thermal spray coating to slough off, sometimes in relatively large pieces, long before the thermal sprayed material has actually worn away, whereas a strong bond renders the thermal spray coating an integral and inseparable component of the substrate.

Several approaches have been undertaken to improve the bond between the thermal spray coating and the substrate. Typically these involve adjusting the composition of the thermally sprayed material and adjusting application process parameters. However, others in the industry have been unable to determine exactly what the application process parameters should be to create a very strong adhesion between the substrate and the spray coating. There present disclosure provides a synergy of process parameters that have resulted in a strong adhesion between the substrate and the thermal spray coating.

### SUMMARY

The present disclosure provides a systematic approach to improving adhesion of a thermal spray coating to a substrate by providing an ideal micro surface texture and cleanliness. In addition, preheating of the substrate is provided to match the thermal expansion of the substrate to the thermal spray. Superior adhesion strength of the thermal spray coating to the substrate is produced by implementing the following specifications prior to coating onto the cylinder bore activated surfaces: surface cleanliness below 30 atomic percent of surface carbon, and preferably below 20 atomic percent of surface carbon; micro surface texture/roughness above 100% Sdr and about 10 μm Ra (or between 9 and 15 μm); and surface temperature between 100 and 200° C.

In one form, which may be combined with or separate from the other forms disclosed herein, a method of coating an inner surface of an engine cylinder bore is provided. The method includes cleaning the inner surface to remove carbon formed thereon, resulting in the inner surface having a maximum of 30 atomic percent of carbon on the inner surface. The method also includes texturing the inner surface until the inner surface exhibits a developed interfacial area ratio (Sdr) of at least than 100%. The method further includes heating the inner surface to a temperature between about 100 and about 200 degrees Celsius to provide a heated surface. The method also includes thermal spraying a coating onto the heated surface to adhere the coating to the heated surface.

In another form, which may be combined with or separate from the other forms disclosed herein, a surface is provided that includes a metal substrate having an activated surface. The activated surface exhibits a range of average three dimensional roughness (Sa) between 9 and 15 μm and a developed interfacial area ratio (Sdr) of at least 100%, and the activated surface has less than 30 atomic percent of surface carbon. A thermal spray coating is adhered to the activated surface of the metal substrate.

In yet another form, which may be combined with or separate from the other forms disclosed herein, a surface is provided that includes a metal substrate having an activated surface and a thermal spray coating adhered to the activated surface of the metal substrate. The thermal spray coating is adhered to the activated surface such that a force of at least 25 Newtons scratched across the thermal spray coating is required to remove the thermal spray coating from the activated surface.

Further additional features may be provided, including but not limited to the following: the step of cleaning the surface including removing carbon until the inner surface has a maximum of 20 atomic percent of carbon on the inner surface; the step of texturing the inner surface including texturing the inner surface until the inner surface exhibits a range of average three dimensional roughness (Sa) between 9 and 15 μm; the steps of cleaning and heating being performed by plasma treating the inner surface; the steps of cleaning, texturing, and heating including using at least one laser to accomplish the cleaning, texturing, and heating; the step of texturing including dry machining the inner surface; the step of heating including induction heating and/or infrared heating; the steps of cleaning and texturing including subjecting the inner surface to chemical etching; the step of cleaning including generating ionized plasma onto the inner surface; the step of cleaning further including applying carbon dioxide to the inner surface; the step of cleaning including generating DC plasma onto the inner surface; the step of cleaning further including applying carbon monoxide to the inner surface; and the steps of texturing, cleaning, heating, and thermal spraying resulting in the coating being adhered to the inner surface such that a force of at least 25 Newtons scratched across the coating is required to remove the coating from the inner surface.

An engine block defining an engine cylinder bore coated by the method disclosed is also provided.

Additional further features of the surface may be provided, such as: the thermal spray coating being adhered to the activated surface by heating the inner surface to a temperature between about 100 and about 200 degrees Celsius; the activated surface having less than 20 atomic percent of surface carbon; the thermal spray coating being adhered to the activated surface such that a force of at least 25 Newtons scratched across the thermal spray coating is required to remove the thermal spray coating from the activated surface; the surface defining an inner wall of an engine cylinder bore in an engine block; the metal substrate being substantially comprised of aluminum; and the thermal spray coating being one of steel and a steel alloy.

Further aspects, advantages, and areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic view of an internal combustion engine block with an enlarged view of a cylinder wall, in accordance with the principles of the present disclosure;

FIG. 2A is a greatly enlarged view of the cylinder wall taken along line 2-2 of FIG. 1, schematically showing the micro surface texture of the cylinder wall, according to the principles of the present disclosure;

FIG. 2B is a view of the cylinder wall of FIG. 2A with a thermal spray coating applied thereto, in accordance with the principles of the present disclosure;

FIG. 3 is a block diagram illustrating a method of coating an inner surface of an engine cylinder bore, according to the principles of the present disclosure;

FIG. 4 is a Venn diagram illustrating example scratch test results for surfaces exhibiting factors of the present disclosure; and

FIG. 5 a grayscale photograph illustrating the inner surface of FIGS. 1-2B having the thermal spray coating metallurgically bonded thereto, at a zoom of 120,000 times, in accordance with the principles of the present disclosure.

### DETAILED DESCRIPTION

The following description is merely exemplary in nature and is not intended to limit the present disclosure or its application or uses.

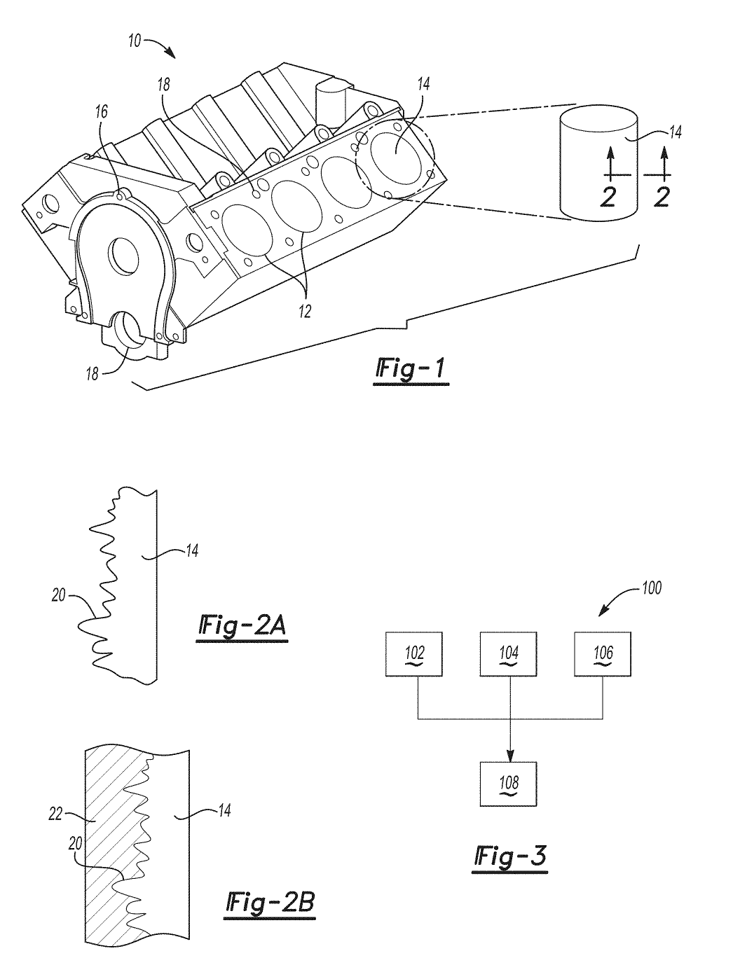

With reference to FIG. 1, an internal combustion engine block is illustrated and generally designated by the reference number 10. The engine block 10 typically includes a plurality of cylinders 12 having interior cylinder walls 14 and numerous flanges 16 and openings 18 for threaded fasteners and other features for receiving and securing components such as cylinder heads, shafts, manifolds and covers (all not illustrated). On the right side of FIG. 1 is an enlarged representation of the cylinder wall 14. The cylinder wall 14 may be a surface of a substrate such as an aluminum or aluminum alloy engine block 10 or a surface of an iron sleeve that has been installed in the engine block 10. In either case, the surface finish of the cylinder wall 14 may be a standard machine profile which is mechanically roughened or activated and preferably defines an average two dimensional surface roughness (Ra) of between about 4 to 25 μm (microns).

It will be appreciated that although illustrated in connection with the cylinder wall 14 of an internal combustion engine block 10, the present disclosure provides benefits and is equally and readily utilized with other cylindrical surfaces such as the walls of hydraulic cylinders and flat surfaces such as planar bearings which are exposed to sliding, frictional forces.

Referring now to FIG. 2A, a greatly enlarged cross section of the cylinder wall 14 schematically illustrates the substrate surface activation and/or micro surface texture 20 of the treated or prepared surface of the cylinder wall 14. The substrate surface texture 20 may be prepared through a variety of methods including, but not limited to, water jet erosion, mechanical roughening, grit blasting, laser texturing, chemical etching and plasma etching.

Referring now to FIG. 2B, a greatly enlarged cross section of the cylinder wall 14 schematically illustrates the micro surface texture 20 of the cylinder wall 14 with a thermal spray coating 22 applied and adhered thereto. Typically, the thermal spray coating 22 for the cylinder wall 14 described herein, after honing, may be on the order of 150 μm and is typically within the range of from 130 μm to 175 μm. Other substrates and applications may, and typically will, require thermal spray coatings 22 having greater of lesser thicknesses. The thermal spray coating 22 may be a steel alloy, another metal or alloy, a ceramic, or any other thermal spray material suited for the service conditions of the product and may be applied by any one of the numerous thermal spray processes such as plasma, detonation, wire arc, flame or HVOF suited to the substrate and material applied.

Superior adhesion strength of the sprayed coating 22 to the cylinder wall substrate 14 is achieved by implementing the following specifications prior to coating onto the cylinder bore activated surface 20: 1) surface roughness/micro surface texture 20 at or above 100% Sdr (explained below) and about 10 μm Ra; 2) surface cleanliness below 30 atomic percent of surface carbon, and preferably below 20 atomic percent of surface carbon; and 3) surface temperature in the range of 100 to 200° C. at the time of coating. For maximum adhesion strength, all three are present.

Regarding the first factor, micro surface texture, adhesion of the thermal spray layer 22 to the cylinder wall 14 is improved when percent of micro surface texture on the activated surface 20 of the prepared substrate wall 14 equals or exceeds 100% Sdr. Sdr, also referred to as the developed interfacial area ratio, in percent, is computed from the standard equation:

Sdr=Surface Area of the Textured Surface−Cross Sectional Area/Cross Sectional Area

For example, a unit of cross sectional area which has two units of area of textured surface has an Sdr percent of 100 (2−1/1). Sdr's below 100% generally provide compromised ruggedness, durability, and service life. Accordingly, it should be understood that the most significant benefits of the present disclosure are achieved when the Sdr is at or above 100%.

Average roughness is referred to as Sa, which is the average surface roughness evaluated over the complete three dimensional surface. The average surface roughness, Sa, is computed from the standard equation:

Sa=∫∫a|Z(x,y)|dxdy

where x, y and Z are measurements in the three orthogonal axes. The preferred range of Sa is between 9 and 15 μm whereas an operable, though less desirable range, is between 7 and 18 μm. An Sa of about 10 μm is preferred in some examples.

It should be understood that the Sdr and Sa measurements are three dimensional and that the micro surface texture achieved by the processes delineated below and represented by Sdr and Sa may be thought of or considered as a fractal, that is, a surface having a never ending pattern that is self-similar at different scales. Such micro surface texture is believed to enhance adhesion of the thermal spray coating by providing connections between the textured surface of the substrate and the thermal spray coating at multiple dimensional sizes or scales from sub-microscopic to microscopic.

While undertaken in general accordance with conventional techniques, it is deemed worthwhile to briefly describe the analysis steps undertaken to properly measure the foregoing parameters. First, tilt and macro surface curvature (such as would exist with cylinder walls), if any, are removed so that the measurement taken is flattened to a plane for analysis. Next, the area of interest is defined by histogram mapping. In a third step, similar to the first step, any curvature of the surface, is further removed for the selected area. Then a missing point is restored and a 0.25 mm three dimensional Gaussian filter is applied. With these preliminary steps and under these conditions, the foregoing roughness parameters can accurately be obtained.

Regarding the cleanliness factor, the textured surface 20 of the substrate 14 preferably has an atomic percent of surface carbon below 30%, and more preferably below 20%. In some cases, the atomic percent of surface carbon may be at or below 10%. Such low levels of surface carbon greatly increases the adhesion strength of the thermal spray coating 22 onto the surface profile 20 of the substrate wall 14.

Regarding the heating factor, it is preferred that the surface temperature of the substrate 14 be heated to a temperature of between about 100° C. and about 200° C. The heated surface 20 of the substrate wall 14 allows the thermal expansion of the substrate 14 to more closely match that of the thermal spray coating 22, which provides for better adhesion.

When all three factors of good cleanliness (low surface carbon), good micro surface texture (e.g., at least 100% Sdr), and preheating the substrate (to between 100 and 200° C.) were present, the adhesion strength of the thermal spray coating 22 to the substrate wall 14 was better than observed in the past. For example, the thermal spray coating 22 was adhered to the activated surface 20 of the substrate 14 such that a force of about 50 Newtons, or at least about 50 Newtons (50+ Newtons), scratched across the thermal spray coating 22 was required to remove the thermal spray coating 22 from the textured or activated surface 20. In other words, a load is applied normal to the surface and scratched across the surface in such a scratch test. In any event, the present disclosure provides a surface wall 14 having a thermal spray coating 22 adhered to the activated surface 20 such that a force of at least about 25 Newtons scratched across the thermal spray coating 22 is required to remove the thermal spray coating 22 from the activated surface 20; and more preferably, a force of at least 30 Newtons is required to remove the thermal spray coating 22 from the activated surface 20.

Referring now to FIG. 3, a method of coating an inner surface of an engine cylinder bore, such as the engine cylinder bore wall 14 having inner micro surface texture 20, is illustrated and generally designated at 100. The method 100 includes a step 102 of cleaning the inner surface 20 to remove carbon formed thereon, resulting in the inner (textured) surface 20 having a maximum of 30 atomic percent of carbon on the inner surface 20. In some cases, the surface 20 may be cleaned so that the inner surface 20 has a maximum of 20 atomic percent of carbon on the inner surface 20, or 10 atomic percent of carbon on the inner surface 20.

The method 100 further includes a step 104 of texturing the inner surface 20 until the inner surface 20 exhibits a developed interfacial area ratio Sdr of equal to or greater than 100%. In some cases, the texturing step 104 may include texturing the inner surface 20 until the inner surface 20 exhibits a range of average three dimensional roughness Ra between 9 and 15 μm, or at about 10 μm.

The method 100 also includes a step 106 of heating the inner surface 20 to a temperature between about 100 and about 200 degrees Celsius to provide a heated surface 20 prior to application of the spray coating 22, so that thermal expansion of the surface 20 matches that of the thermal spray 22.

The method 100 then includes a step 108 of thermal spraying a coating 22 onto the heated surface 20 to adhere the coating 22 to the heated surface 20, as explained above.

The steps 102, 104, 106 of treating the surface 20 can be accomplished in a number of different ways. For example, the steps of cleaning 102 and texturing 104 may be performed by plasma treating the surface 20. Or, each of the steps of cleaning 102, texturing 104, and heating 106 may include using at least one laser to accomplish the cleaning, texturing, and heating. Another alternative for applying the texturing in the texturing step 104 is by dry machining the surface 20. The heating step 106 may include induction heating and/or infrared heating. In another example, the steps of cleaning 102 and texturing 104 include subjecting the inner surface 20 to chemical etching.

In yet another example, the step of cleaning 102 includes generating ionized plasma onto the inner surface 20. The ionized plasma may be sputtered onto the surface 20, for example. The ionized plasma may be applied alone or with carbon dioxide, by way of example.

In still another example, the step of cleaning 102 includes generating DC plasma onto the inner surface 20. The DC plasma may be sputtered onto the surface 20, for example. The DC plasma may be applied alone or with carbon monoxide, by way of example.

As explained above, texturing, cleaning, and heating the surface 20 to the specifications described above results in a superior adhesion strength of the coating 22 to the surface 20. Thus, the steps of texturing, cleaning, heating, and thermal spraying 102, 104, 106, 108 result in the coating 22 being adhered to the inner surface 20 such that a force of at least 25 Newtons scratched across the coating 22 is required to remove the coating 22 from the inner surface 20. In some examples, a force of at least 30 Newtons scratched across the coating 22, while applying force in a normal direction, is required to remove the coating 22 from the surface 20.

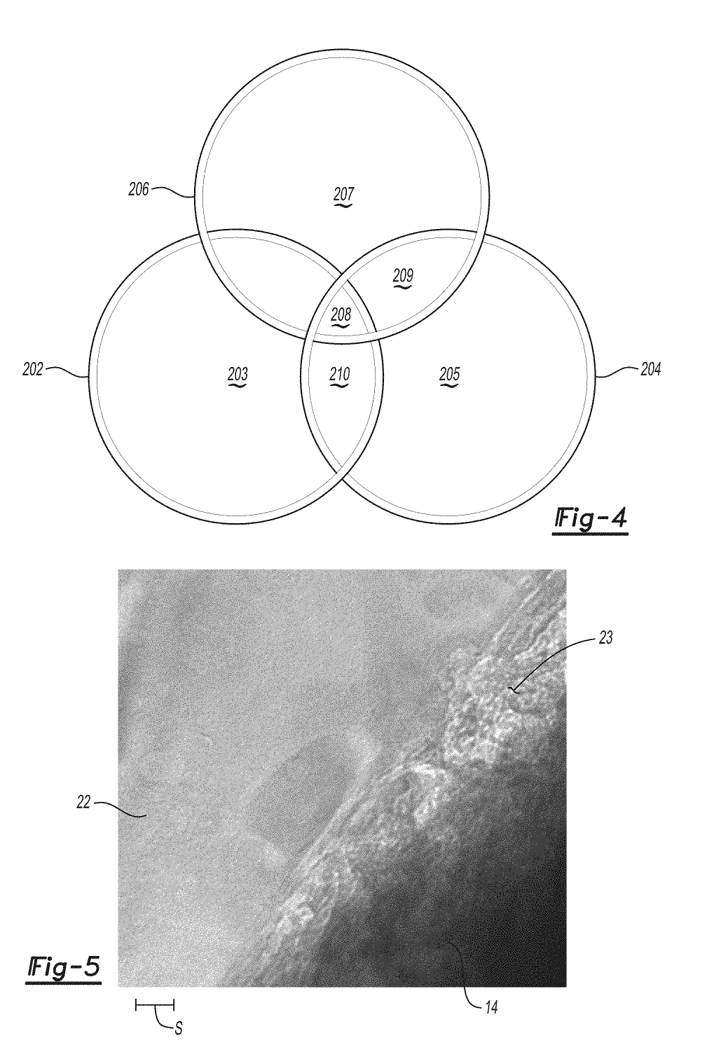

For example, referring now to FIG. 4, a Venn diagram is illustrated showing the effect of each of the cleaning, texturing, and heating as described herein. Each circle 202, 204, 206 represents one of cleaning, texturing, and heating of the substrate surface. For example, circle 202 represents a clean surface that has a maximum of 20 atomic percent carbon; circle 204 represents texturing the surface so that the surface has at least 100% Sdr; and circle 206 represents heating the surface to a temperature between about 100 and about 200 degrees C. Region 203 represents a region of the cleaning circle 202 where cleaning alone is performed without texturing beyond the initial activation and without heating. Region 205 represents a region of the texturing circle 204 where texturing alone is performed without cleaning and without heating. Region 207 represents a region of the heating circle 206 where heating alone is performed without texturing beyond the initial activation and without cleaning. Region 208 is the intersection of each of the circles 202, 204, 206, where all three of the cleaning, texturing, and heating are performed. Region 209 is where the heating circle 206 intersects with the texturing circle 204, but no cleaning is performed. Region 210 is where the cleaning circle 292 intersects with the texturing circle 204, but no heating is performed.

As measured by scratching a tool across the coating 22 by applying a force normal to the surface 20, if cleaning alone was performed on the surface 20 (to bring the surface atomic percentage to a maximum of 20 atomic percent carbon), as shown in region 203 of circle 202, testing showed that a force of 17.5 Newtons was required to remove the coating 22 from the activated surface 20. If texturing alone was used on the surface 20 (to give the surface 20 an Sdr of at least 100%), as shown in region 205 of circle 204, testing showed that a force of 15 Newtons was required to remove the coating 22 from the activated surface 20. If texturing and cleaning were performed on the surface 20, as shown in region 210 (the intersection of circles 202 and 204), testing showed that a force of 25 Newtons was required to remove the coating 22 from the activated surface 20. If texturing and heating were performed on the surface 20, as shown in region 209 (the intersection of circles 204 and 206), testing showed that a force of 10 Newtons was required to remove the coating 22 from the activated surface 20. Most notable, if all three of cleaning, texturing, and heating were performed on the surface 20, as shown in region 208 (the intersection of all three circles 202, 204, 206), testing showed that a force of at least 50 Newtons (50+ Newtons) was required to remove the coating 22 from the activated surface 20.

Moreover, evidence of metallurgical bonding/diffusion was observed between the coating 22 and the surface 14 when the surface 14 was micro textured, cleaned, and heated as described herein. For example, referring to FIG. 5, the metal aluminum substrate 14 is illustrated having the thermal spray coating 22 metallurgically bonded thereto. FIG. 5 is zoomed in at 120,000 times, with a scale s illustrated in the lower left corner having a length of 10 nm. The metal substrate 14 is illustrated on the right, with the thermal spray coating 22 on the left. An interlayer region 23 between the coating 22 and the substrate 14 has a crystalline microstructure formed of a combination of the iron from the thermal spray coating 22 and the aluminum from the substrate 14. This shows that the thermal spray coating 22 has metallurgically bonded with the substrate 14 to form the interlayer 23.

It will be apparent that modifications and variations are possible without departing from the scope of the invention defined in the appended claims. More specifically, although some aspects of the present disclosure are identified herein as preferred or particularly advantageous, it is contemplated that the present invention is not necessarily limited to these preferred aspects of the invention.

1. A method of coating an inner surface of an engine cylinder bore, the method comprising:
cleaning the inner surface to remove carbon formed thereon, resulting in the inner surface having a maximum of 30 atomic percent of carbon on the inner surface;
texturing the inner surface until the inner surface exhibits a developed interfacial area ratio of at least 100%;
heating the inner surface to a temperature between about 100 and about 200 degrees Celsius to provide a heated surface; and
thermal spraying a coating onto the heated surface to adhere the coating to the heated surface.

2. The method of claim 1, wherein the step of cleaning the surface includes removing carbon until the inner surface has a maximum of 20 atomic percent of carbon on the inner surface.

3. The method of claim 2, wherein the step of texturing the inner surface includes texturing the inner surface until the inner surface exhibits a range of average three dimensional roughness between about 9 and about 15 μm.

4. The method of claim 3, wherein the steps of cleaning and heating are performed by plasma treating the inner surface.

5. The method of claim 3, wherein the steps of cleaning, texturing, and heating include using at least one laser to accomplish the cleaning, texturing, and heating.

6. The method of claim 3, wherein the step of texturing includes dry machining the inner surface.

7. The method of claim 3, wherein the step of heating includes at least one of induction heating and infrared heating.

8. The method of claim 3, wherein the steps of cleaning and texturing include subjecting the inner surface to chemical etching.

9. The method of claim 3, wherein the step of cleaning includes generating ionized plasma onto the inner surface.

10. The method of claim 9, wherein the step of cleaning further includes applying carbon dioxide to the inner surface.

11. The method of claim 3, wherein the step of cleaning includes generating DC plasma onto the inner surface.

12. The method of claim 11, wherein the step of cleaning further includes applying carbon monoxide to the inner surface.

13. The method of claim 3, wherein the steps of texturing, cleaning, heating, and thermal spraying result in the coating being adhered to the inner surface such that a force of at least 25 Newtons scratched across the coating is required to remove the coating from the inner surface, the method further including forming a metallurgical bond between the inner surface and the thermal spray coating.

14. An engine block defining an engine cylinder bore coated by the method of claim 3.

15. A surface comprising:
a metal substrate having an activated surface, the activated surface exhibiting a range of average three dimensional roughness between about 9 and about 15 μm and a developed interfacial area ratio of at least 100%, the activated surface having less than 30 atomic percent of surface carbon; and
a thermal spray coating adhered to the activated surface of the metal substrate.

16. The surface of claim 15, wherein the thermal spray coating is adhered to the activated surface by heating the inner surface to a temperature between about 100 and about 200 degrees Celsius.

17. The surface of claim 15, the activated surface having less than 20 atomic percent of surface carbon.

18. The surface of claim 17, wherein the thermal spray coating is adhered to the activated surface such that a force of at least 25 Newtons scratched across the thermal spray coating is required to remove the thermal spray coating from the activated surface, the thermal spray coating being metallurgically bonded to the metal substrate, the surface defining an inner wall of an engine cylinder bore in an engine block, the metal substrate being substantially comprised of aluminum and the thermal spray coating being one of steel and a steel alloy.

19. A surface comprising:
a metal substrate having an activated surface; and
a thermal spray coating adhered to the activated surface of the metal substrate, wherein the thermal spray coating is adhered to the activated surface such that a force of at least 25 Newtons scratched across the thermal spray coating is required to remove the thermal spray coating from the activated surface.

20. The surface of claim 19, wherein the thermal spray coating is metallurgically bonded to the metal substrate.
